(19) United States
(12) Patent Application Publication
(10) Pub. No.: US 2021/0309367 A1
(43) Pub. Date: Oct. 7, 2021

(54) MECHANICAL PACKAGE RELEASE SYSTEM

(71) Applicant: Foras Cogitare LLC, Stedman, NC (US)

(72) Inventor: Morgan Taylor Smee, Stedman, NC (US)

(73) Assignee: Foras Cogitare LLC, Stedman, NC (US)

(21) Appl. No.: 16/840,993

(22) Filed: Apr. 6, 2020

(51) Int. Cl. B64D 1/12; B64C 39/02

(52) U.S. Cl. CPC B64D 1/12; B64C 2201/128; B64C 39/024

(57) ABSTRACT

A package release system for delivering packages using radio controlled or autonomous vehicle like a drone. The package is carried at a first angle then released when the package changes angles such as when set on the ground.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

### Field of the Invention

The present invention relates to a device for attaching a package to a remote controlled or autonomous vehicle and releasing it remotely.

### Description of Related Art

The use of remote controlled vehicles such as drones, delivery vehicles, military/police vehicles, explosive clearance vehicles, and the like is now widely accepted. The delivery of a package by drone is now a reality and most remote vehicles are called on to bring a package and leave it at some point. Delivery of products, explosives, or other packages would be useful to deliver by remote way if such was relatively easy to use and effective.

One solution is to hang a package from a series of tension supports and using the weight of the package upon landing to release the package. While this does work, it easily gets tangled and can make release difficult or, in some cases, impossible. If the remote controlled vehicle package delivery business is to thrive, better means for package release from a remote controlled vehicle is needed.

### BRIEF SUMMARY OF THE INVENTION

The present invention relates to the discovery that a two-piece release system which carries the package at a first angle and releases it at a second angle (usually when it is in position to be released), such as resting on the ground, and solves many of the problems with current delivery strategies.

Accordingly, in one embodiment, there is a mechanical package release system designed for hanging attachment and release of the package to a remote controlled or autonomous vehicle comprising:
a) a first piece, having a base, designed for attaching to the package further comprising a protuberance on the base consisting of an upright pillar topped with a cylinder oriented perpendicular to a length of the first piece and a hook fixedly attached to the first end or the pillar oriented at a first hook angle relative to the base; and
b) a second piece designed for attaching to the remote controlled or autonomous vehicle having a channel which mates with the first piece cylinder and a locking acceptor channel for locking the first piece hook into the second piece when the package is at a first hanging angle and which disconnects the first piece and second piece when the package is at a second hanging angle that is not the first hanging angle.

In another embodiment, there is a mechanical package release system designed for hanging attachment of the package to a remote controlled or autonomous vehicle comprising:
a) a first piece designed for attaching to the package;
b) a second piece designed for attaching to the remote controlled vehicle; and
c) wherein the first piece is removably and rotatably connected to the second piece such that the first and second piece will separate by the force of gravity when the package is at a selected angle.

### BRIEF DESCRIPTION OF THE DRAWINGS

FIG. 1 is a perspective view of the package release system of the invention.

FIG. 2 is a perspective view of the system attached to a package and locked in during flight of a drone.

FIG. 3 shows the package from FIG. 2 when the package changes angle by being set on the ground causing the two-piece system to separate.

FIG. 4 is a perspective view of a cross section of the system while being flown on a drone and the two pieces locked together.

FIG. 5 is a perspective view of a cross section of the system having been placed on a flat surface, thus unlocking the two pieces.

FIG. 6 is a perspective view of the two pieces separated after package delivery.

FIG. 7 is an alternate embodiment wherein the second piece is mounted on a robotic vehicle (not a drone).

FIG. 8 is an alternate embodiment for delivery of a package by a land vehicle to a vertical wall.

FIG. 9 is a perspective view of an alternative second piece.

### DETAILED DESCRIPTION OF THE INVENTION

While this invention is susceptible to embodiment in many different forms, there is shown in the drawings, and will herein be described in detail, specific embodiments with the understanding that the present disclosure of such embodiments is to be considered as an example of the principles and not intended to limit the invention to the specific embodiments shown and described. In the description below, like reference numerals are used to describe the same, similar, or corresponding parts in the several views of the drawings. This detailed description defines the meaning of the terms used herein and specifically describes embodiments in order for those skilled in the art to practice the invention.

### Definitions

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

The term “comprising” is not intended to limit inventions to only claiming the present invention with such comprising language. Any invention using the term comprising could be separated into one or more claims using “consisting essentially of”, “consisting” or “consisting of” claim language and is so intended.

Reference throughout this document to “one embodiment”, “certain embodiments”, “an embodiment”, or similar terms means that a particular feature, structure, or characteristic described in connection with the embodiment is included in at least one embodiment of the present invention. Thus, the appearances of such phrases in various places throughout this specification are not necessarily all referring to the same embodiment. Furthermore, the particular features, structures, or characteristics may be combined in any suitable manner in one or more embodiments without limitation.

The term “or”, as used herein, is to be interpreted as an inclusive or meaning any one or any combination. Therefore, “A, B, or C” means any of the following: “A; B; C; A and B; A and C; B and C; A, B, and C”. An exception to this definition will occur only when a combination of elements, functions, steps, or acts are in some way inherently mutually exclusive.

The drawings featured in the figures are for the purpose of illustrating certain convenient embodiments of the present invention and are not to be considered as limitation thereto. The term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein, and use of the term “means” is not intended to be limiting.

As used herein, the term “mechanical” refers to a device that has parts that move relative to one another and without the use of anything digital, or use of electricity or other power other than gravity.

As used herein, the term “package release system” refers to a device which attaches to a remote controlled or autonomous vehicle and releases the package at the desired location. In one embodiment, the package release system disconnects when the hanging angle is between about 0 degrees and about 15 degrees.

As used herein, the term “hanging attachment” refers to rotation around the cylinder which causes the package to hang at an angle based on weight and where the first piece is positioned on the package.

As used herein, the term “package” refers to a container, such as a box or case, in which something is or may be packed and designed for delivery to a desired location.

As used herein, the term “remote controlled or autonomous vehicle” refers to a vehicle like a drone, remote controlled land vehicle, and the like, designed to deliver a desired package and is controlled from a distance by the use of radio or electronic signals.

As used herein, the term “first piece” refers to the part of the package release system that attaches to the package. It can be attached by any convenient method such as straps, glue, tape, and the like. In general, it consists of a base for package attachment and a protuberance. In one embodiment, the base is rectangular and is mounted along the center of the package somewhere between a first end and middle, as shown in the Figures.

As used herein, the term “protuberance” refers to a portion that sticks up from the top surface of the first piece base. It consists of an upright pillar topped with a cylinder oriented perpendicular to a length of the base.

As used herein, the term “upright pillar” refers to a column or shaft that extends vertically from the top of the base and designed to mount the column on top of the pillar. See the Figures for embodiments of the pillar.

As used herein, the term “cylinder” refers to a right circular cylinder with the circular bases, and with the axis joining the two centers of the bases perpendicular to the planes of the two bases. The cylinder is mounted atop the pillar and in a position perpendicular to the length of the base. See especially FIG. 4. Note that while the length can be as desired, it makes sense to make it only as long as needed to fit into the channel.

As used herein, the term “hook” refers to a piece of metal or other material, curved or bent back at an angle, and rigid for catching hold of, or latching into the locking acceptor channel of the second piece. It can be mounted on the base or on the pillar, as needed. In one embodiment, the hook angle is from about 35 degrees to about 45 degrees.

As used herein, the term “second piece” refers to the piece of the system which attaches to the remote controlled or autonomous vehicle. It mates with the first piece cylinder and has a locking acceptor channel for locking the first piece hook into the second piece when the package is at a first hanging angle, and which disconnects from the locking acceptor channel when the package is at an angle that is not the first hanging angle. In some embodiments, it is a level surface or a vertical wall or object. It is assumed that the locking angle is a wide range of hanging angles while the non-first angle for release has a narrow range within 5 or 10 degrees, in one embodiment. It can be attached to the vehicle via any means or angle, including a Picatinny rail mounting system.

As used herein, the term “channel” refers to a passage, groove, or the like which accepts the cylinder of the first piece. As shown in the Figures, it acts to restrict left to right movement between the package and the remote controlled or autonomous vehicle and acts with the cylinder to create a pivot, which adjusts by the weight of the package or when the package is up against a surface such as the ground, a door, a wall, or the like.

As used herein, the term “locking acceptor channel” refers to a passage, groove, or the like which accepts (mates with) the hook and has a locked position and an unlocked position relative to the hook and/or the angle of the package and first piece attached thereto. See Figures for an example.

As used herein, the term “first hanging angle” refers to the angle created between the first piece and the second piece based on the weight of the package being transported by the remote controlled vehicle. It refers to the angle, such that the hook is locked into the locking acceptor channel.

As used herein, the term “second hanging angle or not the first hanging angle” refers to the angle created between the first piece and the second piece based on the weight of the package being transported by the remote controlled or autonomous vehicle. It refers to the angle, such that the hook is unlocked from the locking acceptor channel.

### DRAWINGS

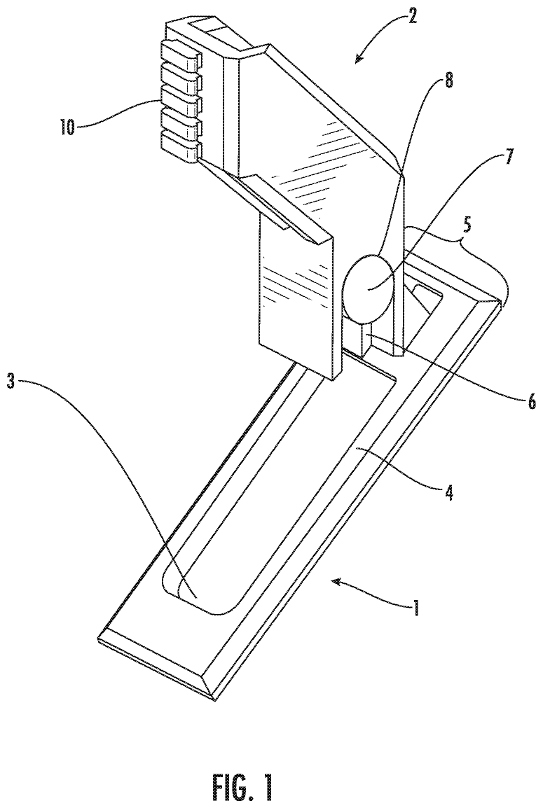

Now referring to the drawings, FIG. 1 is a perspective view of the system of the present invention. The mechanical package release system consists of first piece 1 and second piece 2. First piece 1 is designed to attach to a package while second piece 2 is designed to attach to a remote controlled vehicle like a drone or a robot. The base 4 is designed to attach to the package via an attachment device. The first piece 1, in this embodiment, has attachment section 3 designed to attach to the package, e.g. by use of a strap. The first piece 1 has a protuberance 5 which consists of an upright pillar 6 and a cylinder 7 on top of the pillar 6 oriented perpendicularly to a length of the base.

Second piece 2 has channel 8 for accepting the cylinder 7 when the two pieces are connected. The attachment locking mechanism is shown elsewhere. The second piece 2 allows a package to hang from the second piece 2 by engaging the cylinder 7 in channel 8 and allowing the base to rotate in channel 8 based on gravity where the first piece 1 is mounted, and/or depending if the package is sitting on a surface or not. Second piece 2 also has a device 10 designed, in one embodiment, to attach the second piece via a Picatinny rail to a remote controlled or autonomous vehicle.

FIG. 2 shows a hanging orientation of a package 20 while being carried by an aerial drone 21 relative to ground 22. Second piece 2 is attached 25 to aerial drone 21, and first piece 1 is attached 26 to package 20. The attachment of the first piece 1 toward end of package 23 combined with package weight and gravity acting on package 20, causes package 20 to hang at an angle from a horizontal position. In this embodiment, this is a position where first piece 1 and second piece 2 are locked together in a rotational manner around cylinder 7.

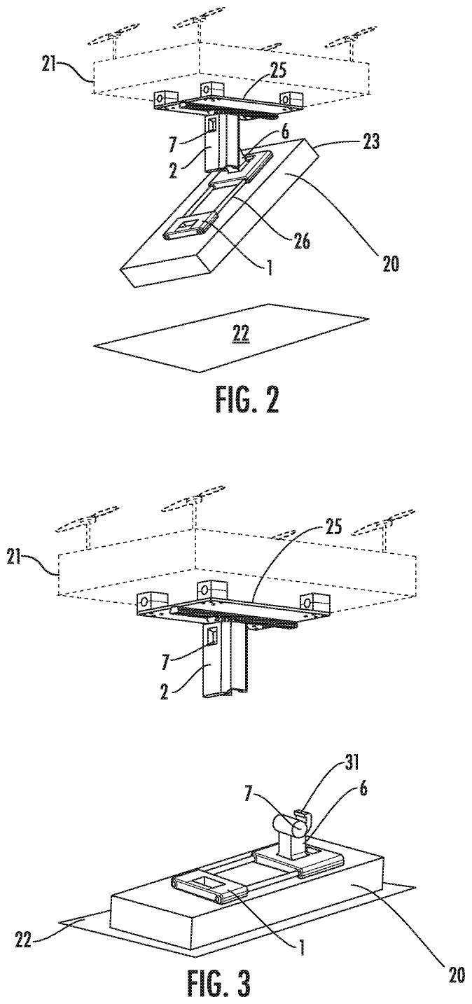

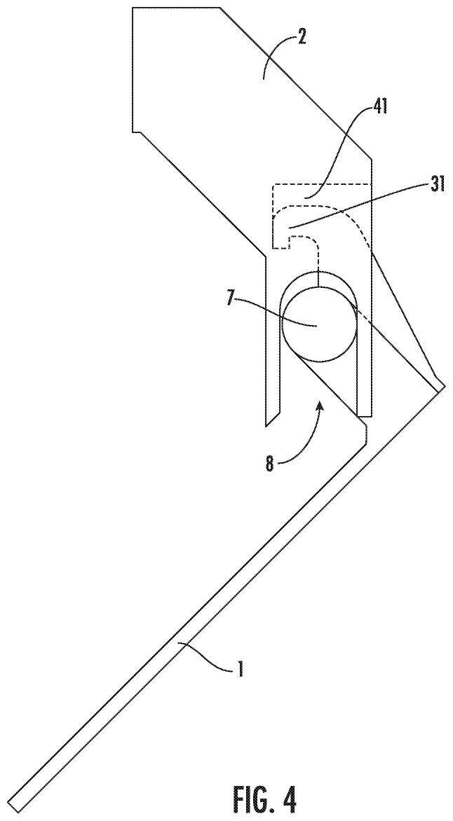

FIG. 3 shows an embodiment where the orientation of package 20 is now horizontal since it is lowered to the ground 22. This allows the second piece 2 to detach from the first piece 1, which in turn allows the aerial drone to fly away without the package 20. In this view, hook 31 is attached to pillar 6 and allows locking of the first piece 1 and second piece 2 based on the angle of the package and thus, the angle of the first piece 1.

FIG. 4 is a cross section of the system while being flown on an aerial drone and the two pieces locked together, as shown in FIG. 2. This view only shows first piece 1 and second piece 2, and not the remote vehicle or package. In this view, locking acceptor channel 41 has mated with hook 31 and as long as the package is above the ground, it will hang at an angle while first piece 1 and second piece 2 are locked together.

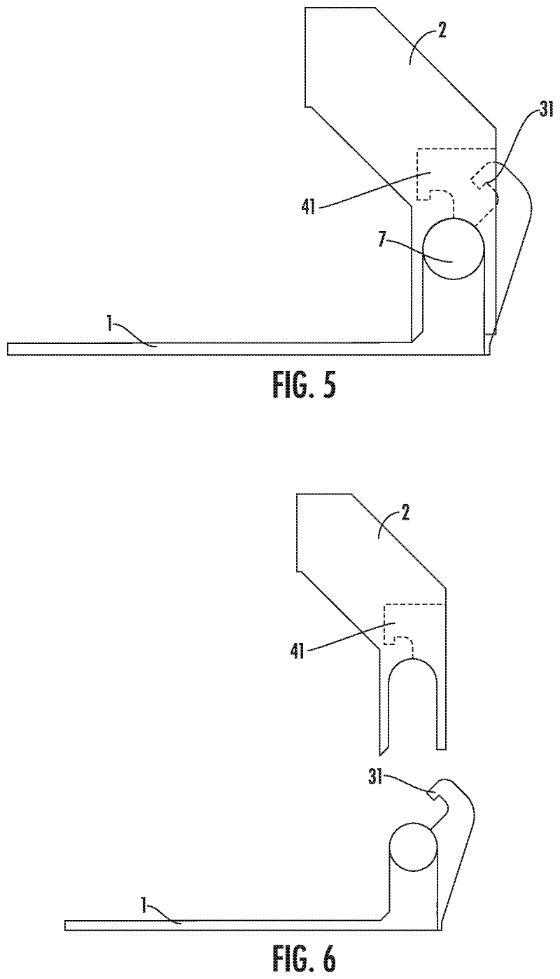

FIG. 5 is a cross section of the system wherein the package is sitting on the ground, as in FIG. 3. In this position, the hook 31 has disengaged from the locking acceptor channel 41 and thus, the first piece 1 and second piece 2 are no longer locked together.

FIG. 6 shows the result of the first piece 1 and second piece 2 being disengaged as the second piece 2 is moving away from the first piece 1, i.e., the aerial drone has dropped off the package and is flying away.

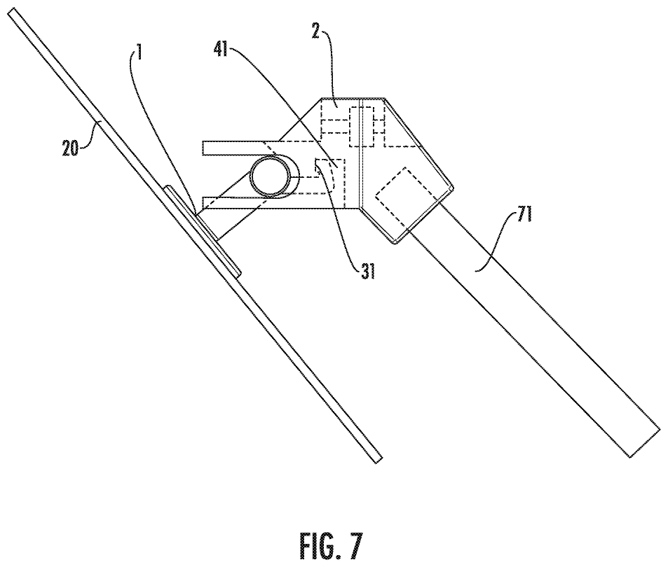

FIG. 7 is an alternate embodiment wherein the second piece is mounted on the mast 71 of a robotic vehicle (not an aerial drone). In this view, the first piece 1 is mounted in the middle of the package 20. The package 20 is being held in this position by action of the hook 31 locked into the locking acceptor channel 41.

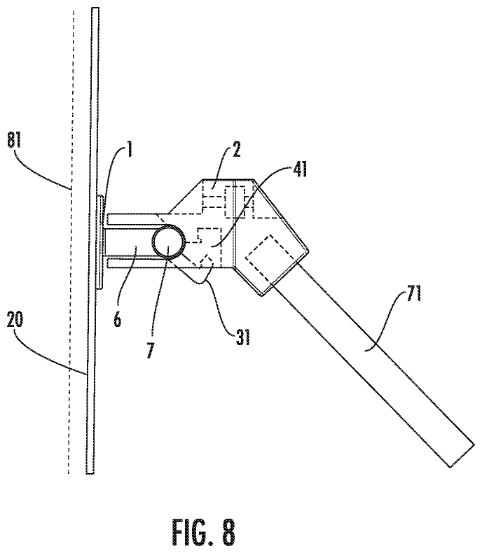

FIG. 8 shows the package 20 has been pressed up against a vertical wall 81 (door, window, etc.) leaving the package oriented vertically (useful in attaching explosives by a police department). Since the second piece 2 has rotated relative to the first piece 1 by this action, the hook 31 is removed from the acceptor locking channel 41 and first piece 1 and second piece 2 may now disengage leaving the package 20 stuck to the vertical surface using an adhesive, magnets, or other means of attachment.

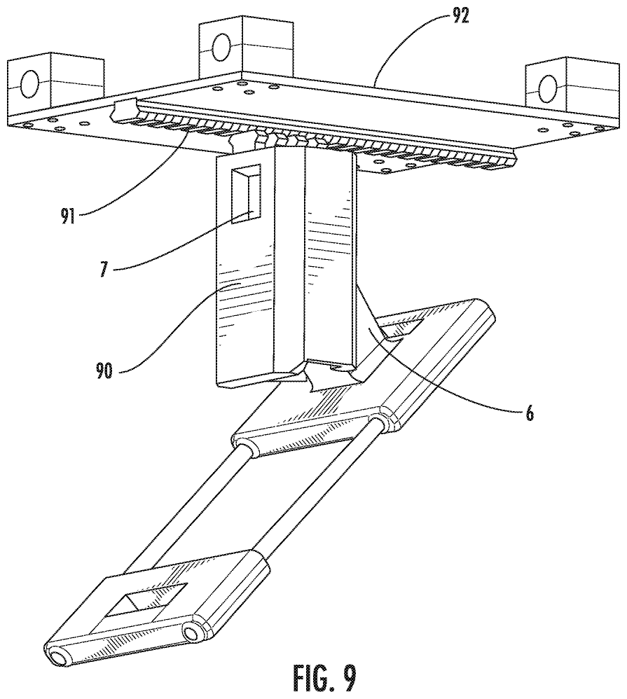

FIG. 9 shows an alternate second piece 90 attached to Picatinny rail 91 on a bottom side of an aerial drone 92. This is a carry position for the system.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials, and the like apparent to those skilled in the art still fall within the scope of the invention as claimed by the applicant.

What is claimed is:

1. A mechanical package release system designed for hanging attachment and release of the package to a remote controlled or autonomous vehicle comprising:
a) a first piece, having a base, designed for attaching to the package further comprising a protuberance on the base consisting of an upright pillar topped with a cylinder oriented perpendicular to a length of the first piece base and a hook fixedly attached to the base or the pillar oriented at a first hook angle relative to the base; and
b) a second piece designed for attaching to the remote controlled or autonomous vehicle having a channel which mates with the first piece cylinder and a locking acceptor channel for rotatably locking the first piece hook into the second piece when the package is at a first hanging angle and which disconnects the first piece and second piece when the package is at a second hanging angle that is not the first hanging angle.

2. The mechanical package release system according to claim 1 wherein the first piece attaches to the package via straps. The mechanical package release system according to claim 1 wherein the remote controlled or autonomous vehicle is an aerial drone.

3. The mechanical package release system according to claim 1 wherein the remote controlled or autonomous vehicle is a ground vehicle.

4. The mechanical package release system according to claim 1 wherein the first hook angle is from about 35 degrees to about 45 degrees.

5. The mechanical package release system according to claim 1 wherein the first and second piece disconnect when the second hanging angle is between about 0 degrees and about 15 degrees.

6. The mechanical package release system according to claim 1 wherein the first piece is mounted on a first end of the package.

7. The mechanical package release system according to claim 1 wherein the first piece is mounted at about the middle of the package.

8. A mechanical package release system designed for hanging attachment of the package to a remote controlled or autonomous vehicle comprising:
a) a first piece designed for attaching to the package;
b) a second piece designed for attaching to the remote controlled or autonomous vehicle; and
c) wherein the first piece is removably and rotatably connected to the second piece such that the first and second piece will separate by the force of gravity when the package is at a selected angle.

9. The mechanical package release system according to claim 8 wherein the selected angle is when the package is parallel to the ground.
